(19) United States
(12) Patent Application Publication
(10) Pub. No.: US 2021/0126933 A1
(43) Pub. Date: Apr. 29, 2021

(54) COMMUNICATION ANALYSIS APPARATUS, COMMUNICATION ANALYSIS METHOD, COMMUNICATION ENVIRONMENT ANALYSIS APPARATUS, COMMUNICATION ENVIRONMENT ANALYSIS METHOD, AND PROGRAM

(71) Applicant: NEC Corporation, Minato-ku, Tokyo (JP)

(72) Inventors: Yuki ASHINO, Tokyo (JP); Ayaka SAMEJIMA, Tokyo (JP)

(73) Assignee: NEC Corporation, Minato-ku, Tokyo (JP)

(21) Appl. No.: 17/254,491

(22) PCT Filed: Jun. 5, 2019
(86) PCT No.: PCT/JP2019/022295

§ 371 Date: Dec. 21, 2020

(30) Foreign Application Priority Data
Jun. 22, 2018 (JP) 2018-118955

(51) Int. Cl. H04L 29/06; H04L 12/26

(52) U.S. Cl. CPC H04L 63/1425; H04L 43/18; H04L 63/1433; H04L 63/1416

(57) ABSTRACT

The present invention includes an acquisition unit (110) that acquires, for communication observed by a sensor apparatus on a network, communication information including behavior information indicating behavior of the communication and transmission source information indicating a transmission source of the communication, a classification unit (120) that classifies the acquired communication information, based on the behavior information, and an output unit (130) that outputs a classification result of the communication information based on the behavior information, together with the transmission source information.

### TECHNICAL FIELD

The present invention relates to a cyber security technique.

### BACKGROUND ART

A cyber attack on a network is increasing year by year, and importance of a security measure against a cyber attack is increasing.

One example of a technique related to a cyber security is disclosed in PTL 1 described below. PTL 1 described below discloses a technique of analyzing a packet distributed on a communication network, quantifying a degree of maliciousness of an access source based on a host access, a port access, an access time interval, an access policy violation, and the like from the access source, and performing a process according to the degree of the maliciousness.

### CITATION LIST

### Patent Literature

[PTL 1] Japanese Patent Application Publication No. 2005-175714

### SUMMARY OF INVENTION

### Technical Problem

The technique in PTL 1 described above determines whether certain communication is malicious, based on an analysis result of a cyber attack that is known (i.e., that actually causes damage to come to the surface). In other words, it is difficult to determine maliciousness of communication related to a cyber attack as long as damage by the cyber attack does not come to the surface. As a result, damage expands before an unknown cyber attack becomes known. A technique for finding an unknown cyber attack in an early stage, and suppressing damage by the cyber attack is desired.

The present invention has been made in view of the above-described problem. One of objects of the present invention is to provide a technique for finding an unknown cyber attack in an early stage, and suppressing expansion of damage by the cyber attack.

### Solution to Problem

A communication analysis apparatus according to the present invention, including:

an acquisition unit for acquiring, for communication observed by a sensor apparatus on a network, communication information including behavior information indicating behavior of the communication and transmission source information indicating a transmission source of the communication;

a classification unit for classifying the acquired communication information, based on the behavior information; and

an output unit for outputting a classification result of the communication information based on the behavior information, together with the transmission source information.

A communication analysis method performed by a computer according to the present invention, the method including:

acquiring, for communication observed by a sensor apparatus on a network, communication information including behavior information indicating behavior of the communication and transmission source information indicating a transmission source of the communication;

classifying the acquired communication information, based on the behavior information; and

outputting a classification result of the communication information based on the behavior information, together with the transmission source information.

A first program according to the present invention causes a computer to execute the communication analysis method described above.

A communication environment analysis apparatus according to the present invention, including:

an acquisition unit for acquiring index information that serves as an index for measuring, based on communication observed by a sensor apparatus on a network, soundness of a network environment of the sensor apparatus;

a determination unit for determining similarity between the acquired index information and reference index information being index information of a network environment that serves as a reference; and

an output unit for performing outputting based on a determination result of the similarity.

A communication environment analysis method performed by a computer according to the present invention, the method including:

acquiring index information that serves as an index for measuring, based on communication observed by a sensor apparatus on a network, soundness of a network environment of the sensor apparatus;

determining similarity between the acquired index information and reference index information being index information of a network environment that serves as a reference; and performing outputting based on a determination result of the similarity.

A second program according to the present invention causes a computer to execute the communication environment analysis method described above.

### Advantageous Effects of Invention

The present invention is able to find an unknown cyber attack in an early stage, and suppress expansion of damage by the cyber attack.

### BRIEF DESCRIPTION OF DRAWINGS

The above-described object, the other objects, features, and advantages will become more apparent from suitable example embodiments described below and the following accompanying drawings.

FIG. 1 is a diagram schematically illustrating processing performed by a communication analysis apparatus according to a first example embodiment.

FIG. 2 is a block diagram illustrating a functional configuration example of the communication analysis apparatus according to the first example embodiment.

FIG. 3 is a block diagram illustrating a hardware configuration of the communication analysis apparatus.

FIG. 4 is a flowchart illustrating a flow of processing performed by the communication analysis apparatus according to the first example embodiment.

FIG. 5 is a diagram illustrating one example of rule information that defines a generation rule of behavior information.

FIG. 6 is a diagram schematically illustrating one example of an observation result of communication in a sensor apparatus.

FIG. 7 is a diagram illustrating one example of communication information generated based on the observation result of the communication illustrated in FIG. 6.

FIG. 8 is a diagram illustrating one example of communication information accumulated in a predetermined storage region.

FIG. 9 is a diagram illustrating one example of an output screen that displays communication time distribution information.

FIG. 10 is a diagram schematically illustrating processing performed by a communication environment analysis apparatus according to a second example embodiment.

FIG. 11 is a diagram schematically illustrating a functional configuration of the communication environment analysis apparatus according to the second example embodiment.

FIG. 12 is a block diagram illustrating a hardware configuration of the communication environment analysis apparatus.

FIG. 13 is a flowchart illustrating a flow of processing performed by the communication environment analysis apparatus according to the second example embodiment.

FIG. 14 is a diagram illustrating one example of rule information that defines a generation rule of index information.

FIG. 15 is a diagram illustrating one example of index information acquired by an acquisition unit.

FIG. 16 is a diagram illustrating one example of reference index information of a sensor apparatus that serves as a determination reference.

FIG. 17 is a diagram illustrating one example of index information of the sensor apparatus to be analyzed.

FIG. 18 is a diagram illustrating one example of the index information of the sensor apparatus to be analyzed.

FIG. 19 is a diagram illustrating one example of a screen including information indicating a degree of similarity between the index information and the reference index information.

### EXAMPLE EMBODIMENT

Hereinafter, example embodiments of the present invention will be described by using drawings. Note that, in all of the drawings, the same components have the same reference numerals, and description thereof will be appropriately omitted. Further, in each block diagram, each block represents a configuration of a functional unit instead of a configuration of a hardware unit unless otherwise described.

### <First Example Embodiment>

### <Outline>

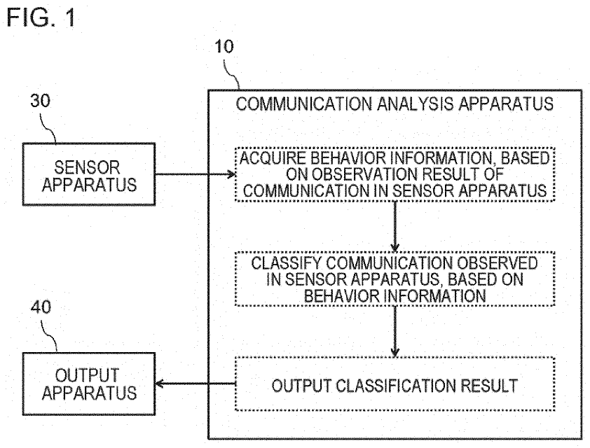

FIG. 1 is a diagram schematically illustrating processing performed by a communication analysis apparatus 10 according to a first example embodiment. The communication analysis apparatus 10 includes a function of outputting information serving as an index that determines a communication risk, based on an observation (reception) result of communication in a sensor apparatus 30. The sensor apparatus 30 is an apparatus for observing communication from a transmission source (communication apparatus), which is not illustrated, on a network. The sensor apparatus 30 outputs a result of observing communication from the transmission source on the network to the communication analysis apparatus 10 or a not-illustrated external storage apparatus at predetermined timing, for example. Note that, although not illustrated in FIG. 1, the plurality of sensor apparatuses 30 may be present on the network.

The communication analysis apparatus 10 can analyze communication observed by the sensor apparatus 30 by transmission source, and acquire information (hereinafter, also expressed as “behavior information”) indicating behavior of the communication. Note that the analysis may be performed in the sensor apparatus 30. In this case, the sensor apparatus 30 outputs information including a result of the analysis (behavior information) to the communication analysis apparatus 10 or the not-illustrated external storage apparatus.

The communication analysis apparatus 10 classifies the communication observed by the sensor apparatus 30, based on the acquired behavior information. Then, the communication analysis apparatus 10 outputs a result of classifying the communication based on the behavior information, together with information (hereinafter, also expressed as “transmission source information”) indicating a transmission source of the communication.

### <Action and Effect>

The communication analysis apparatus 10 according to the present example embodiment outputs a result of classifying communication based on behavior information, together with information indicating a transmission source of the communication. The information output from the communication analysis apparatus 10 may be a clue for an administrator of a network security to find an unknown cyber attack. For example, a classification result of communication based on behavior information is an index indicating whether behavior performed by the communication is ordinary behavior or special behavior that is impossible in a normal condition (that is unprecedented). Furthermore, when communication of unprecedented special behavior is performed from a transmission source that frequently performs communication assumed to be a cyber attack, the communication is likely to be an unknown cyber attack. An administrator of the network security can perform, for example, such an analysis by using an output result of the communication analysis apparatus 10. Then, an administrator of the network security can take advance measures in such a way as to prevent damage of an unknown cyber attack from expanding.

### <Functional Configuration Example of Communication Analysis Apparatus 10>

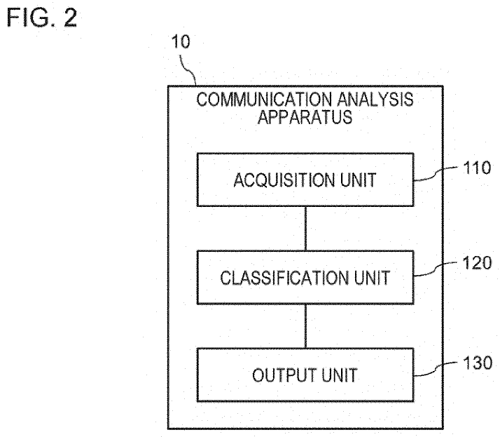

FIG. 2 is a block diagram illustrating a functional configuration example of the communication analysis apparatus 10 according to the first example embodiment. As illustrated in FIG. 2, the communication analysis apparatus 10 includes an acquisition unit 110, a classification unit 120, and an output unit 130.

The acquisition unit 110 acquires communication information including behavior information and transmission source information for communication observed by the sensor apparatus 30 on a network. Herein, the sensor apparatus 30 on the network observes (receives) communication occurring between a transmission source and the sensor apparatus 30 in response to an operation of some sort of program implemented on the transmission source. The behavior information is information indicating behavior of the communication observed (received) by the sensor apparatus 30. Further, the transmission source information is information indicating (identifying) the transmission source that performs the communication. The classification unit 120 classifies the communication information, based on the behavior information. The output unit 130 outputs a classification result of the communication information based on the behavior information, together with the transmission source information.

### <Hardware Configuration Example of Communication Analysis Apparatus 10>

Each functional component unit of the communication analysis apparatus 10 may be achieved by hardware (for example, a hard-wired electronic circuit, and the like) that achieves each functional component unit, and may be achieved by a combination (for example, a combination of an electronic circuit and a program that controls the electronic circuit, and the like) of hardware and software. Hereinafter, a case where each functional component unit of the communication analysis apparatus 10 is achieved by the combination of hardware and software will be further described.

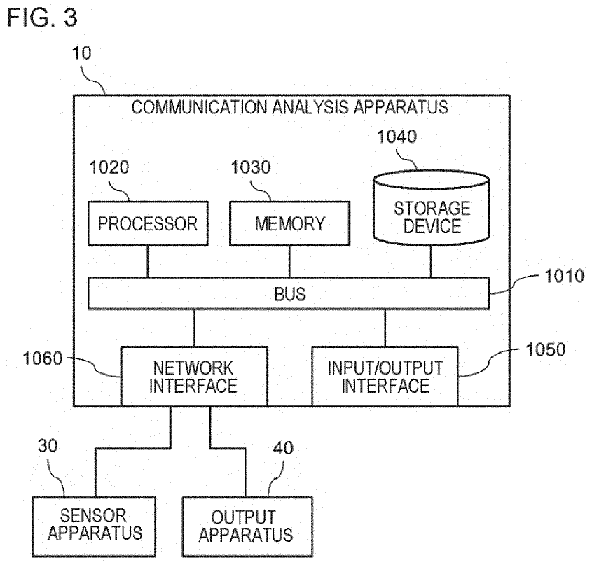

FIG. 3 is a block diagram illustrating a hardware configuration of the communication analysis apparatus 10. As illustrated in FIG. 3, the communication analysis apparatus 10 includes a bus 1010, a processor 1020, a memory 1030, a storage device 1040, an input/output interface 1050, and a network interface 1060.

The bus 1010 is a data transmission path for allowing the processor 1020, the memory 1030, the storage device 1040, the input/output interface 1050, and the network interface 1060 to transmit and receive data with one another. However, a method of connecting the processor 1020 and the like to each other is not limited to a bus connection.

The processor 1020 is a processor achieved by a central processing unit (CPU), a graphics processing unit (GPU), and the like.

The memory 1030 is a main storage apparatus achieved by a random access memory (RAM) and the like.

The storage device 1040 is an auxiliary storage apparatus achieved by a hard disk drive (HDD), a solid state drive (SSD), a memory card, a read only memory (ROM), or the like. The storage device 1040 stores a program module that achieves each function (such as the acquisition unit 110, the classification unit 120, and the output unit 130) of the communication analysis apparatus 10. The processor 1020 reads each program module onto the memory 1030 and executes the program module, and thus each function associated with the program module is achieved.

The input/output interface 1050 is an interface for connecting the communication analysis apparatus 10 and various types of input/output devices. An input device, such as a keyboard and a mouse, and an output device, such as a speaker and a display, may be connected to the input/output interface 1050.

The network interface 1060 is an interface for connecting the communication analysis apparatus 10 to a network. The network is, for example, a local area network (LAN) and a wide area network (WAN). A method of the network interface 1060 connecting to the network may be a wireless connection or a wired connection. The communication analysis apparatus 10 can communicate with the sensor apparatus 30 on the network, another not-illustrated external apparatus, and the like via the network interface 1060.

Note that FIG. 3 is merely an exemplification, and the hardware configuration of the communication analysis apparatus 10 is not limited to the configuration illustrated in FIG. 3.

### <Flow of Processing>

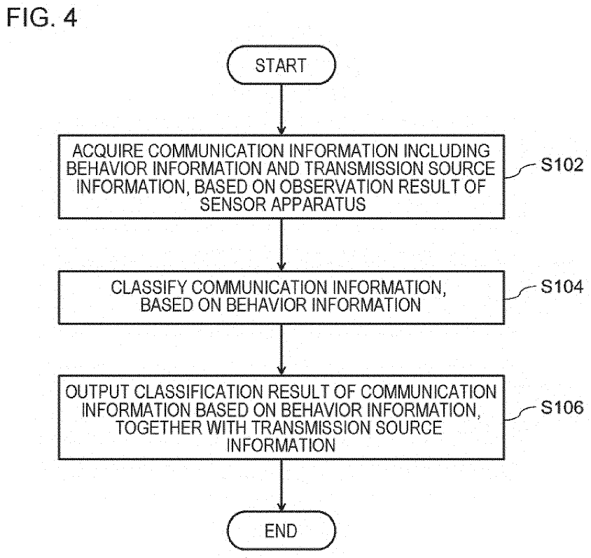

FIG. 4 is a flowchart illustrating a flow of processing performed by the communication analysis apparatus 10 according to the first example embodiment. Hereinafter, the processing performed by the communication analysis apparatus 10 will be described along the flowchart in FIG. 4.

First, the acquisition unit 110 acquires communication information including behavior information and transmission source information, based on an observation result of communication made by the sensor apparatus 30 (S102). The acquisition unit 110 operates as follows, for example.

First, the acquisition unit 110 acquires raw data of a communication packet observed (received) by the sensor apparatus 30. The communication packet includes information related to a transmission control protocol (TCP) or information related to a user datagram protocol (UDP) and an internet protocol (IP). Based on the pieces of information, the acquisition unit 110 can acquire behavior information indicating behavior of communication and transmission source information indicating a transmission source. Herein, the information related to the TCP or the UDP is included in a TCP header or a UDP header of the communication packet. The information related to the TCP included in the communication packet is, for example, a destination TCP port number, a control flag of a TCP packet, and the like. The information related to the UDP included in the communication packet is, for example, a destination UDP port number and the like. Further, the information related to the IP is included in an IP header of the communication packet. The information related to the IP included in the communication packet is, for example, a source IP address, a destination IP address, and the like.

Herein, information, being included in the communication packet, such as a destination port number (destination TCP port number or destination UDP port number), a control flag of a TCP packet, and a destination IP address can be used as information indicating behavior of communication. For example, it is known that a “type (combination) of used destination port numbers”, an “order of a used destination port number”, a “pattern of a control flag of a TCP packet”, a “change in destination IP address”, and the like depend on implementation (program).

In the TCP and the UDP, a port number is assigned according to a service (for example, a port number of a hypertext transfer protocol (HTTP) is 80). For this reason, a “type (combination) of used destination port numbers”, an “order and the number of times of a used destination port number”, and the like are clues to conjecture what kind of purpose a program being used in a transmission source has.

Further, for communication packets from a certain transmission source toward the same destination IP address and the same destination TCP port number, control flags of a TCP packet may be arranged in a specific arrangement order (pattern). As a specific example, a case where a three-way handshake is performed and a connection between a certain transmission source and the sensor apparatus 30 is established is considered. As normal behavior in this case, the transmission source first transmits a communication packet including a set synchronize (SYN) flag toward the sensor apparatus 30. When the sensor apparatus 30 responds to the communication packet, the transmission source further transmits a communication packet including a set acknowledge (ACK) flag. Subsequently, when a data body is transmitted, the transmission source further transmits a communication packet including a set push (PSH) flag. In other words, a pattern of the control flag of the TCP packet such as “SYN→ACK” or “SYN →ACK→PSH” appears in the normal communication behavior of the three-way handshake.

However, a transmission source that transmits a communication packet in a special pattern different from the above-described pattern may be observed. For example, a transmission source that transmits a communication packet including a set reset (RST) flag after a communication packet including a set SYN flag, a transmission source that repeatedly transmits a communication packet including a set ACK flag for multiple times, and the like may be observed. In such a transmission source, a program (malware) used for a special purpose is likely to be operating. In this way, a pattern of a control flag of a TCP packet is also a clue to conjecture what kind of purpose a program being used in a transmission source has.

Further, a plurality of communication packets toward different destination IP addresses may be transmitted from the transmission source in a short period of time by a program used in a transmission source. By extracting the destination IP address from each of the plurality of communication packets, information indicating what kind of communication is performed by the transmission source can be acquired. For example, information indicating that a destination IP address is regularly changed (for example, a destination IP address is shifted one by one) or a destination IP address is randomly changed can be acquired. The information is a clue to conjecture what kind of purpose a program being used in a transmission source has.

Thus, the acquisition unit 110 acquires, as behavior information, information related to at least any one of a destination port number, a control flag of a TCP packet, and a destination IP address.

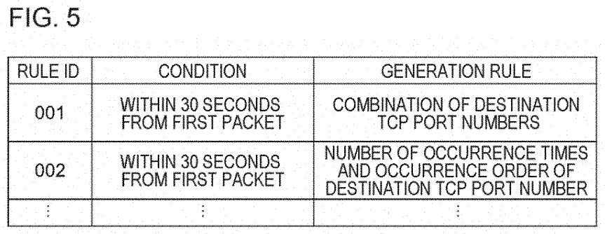

Specifically, the acquisition unit 110 acquires the behavior information according to a predetermined rule (for example: FIG. 5). FIG. 5 is a diagram illustrating one example of rule information that defines a generation rule of the behavior information. The information illustrated in FIG. 5 is stored in advance in a storage region such as the memory 1030 and the storage device 1040, for example. In the example in FIG. 5, each record is formed of three columns that are a “rule identifier (ID)”, a “condition”, and a “generation rule”. The “rule ID” is information for identifying each piece of rule information. The “condition” is information for determining a range of data for generating one piece of behavior information, and any information may be set. For example, a condition that is “within 30 seconds from observation of first packet” is set in first and second rows in FIG. 5. In this case, one or more communication packets (including a first packet) observed in a section in terms of time that is “within 30 seconds from observation of first packet” are determined as data for generating one piece of behavior information. Note that “one or more communication packets” are determined by transmission source. The “generation rule” is information for defining a generation rule of behavior information, and any information may be set. The acquisition unit 110 acquires behavior information from the above-described “one or more communication packets” according to a definition of the “generation rule”. For example, when the “generation rule” in the first row in the example in FIG. 5 is applied, the acquisition unit 110 extracts a destination TCP port number from each of one or more communication packets, and acquires behavior information indicating a combination of the destination TCP port numbers.

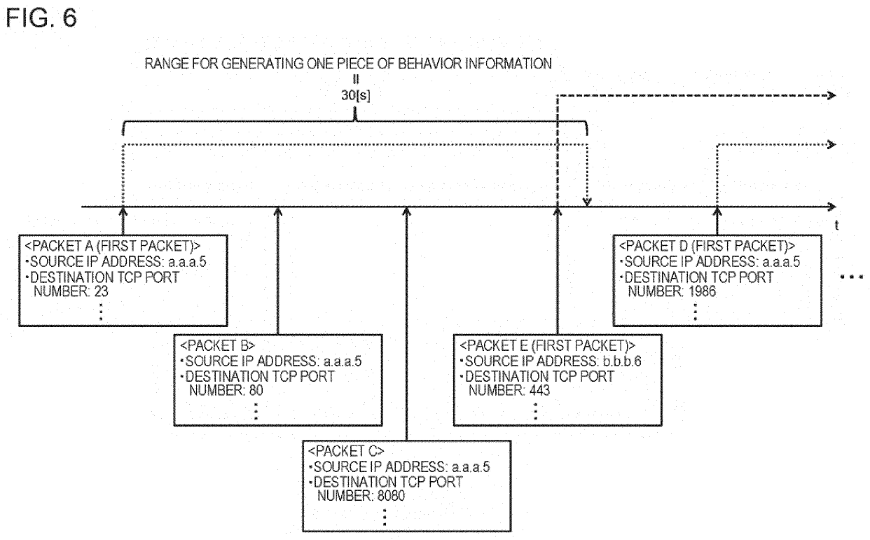

Herein, a specific operation of the acquisition unit 110 will be described by using FIG. 6. Note that, herein, it is assumed that the acquisition unit 110 uses the information illustrated in FIG. 5. FIG. 6 is a diagram schematically illustrating one example of an observation result of communication in the sensor apparatus 30. In the example illustrated in FIG. 6, the sensor apparatus 30 observes at least five communication packets (communication packets A to E). In the example in FIG. 6, the communication packets A to D are communication packets transmitted from a transmission source “a.a.a.5”, and the communication packet E is a communication packet transmitted from a transmission source “b.b.b.6”.

When the acquisition unit 110 acquires data as illustrated in FIG. 6, the acquisition unit 110 recognizes the communication packet A observed first for the transmission source “a.a.a.5” as a “first packet”. Further, the acquisition unit 110 recognizes the communication packet B and the communication packet C observed for the same transmission source “a.a.a.5” as a packet observed “within 30 seconds from the observation of the first packet”, based on a difference from an observation time of the communication packet A. Further, the acquisition unit 110 recognizes the communication packet D observed for the same transmission source “a.a.a.5” as a new “first packet” different from the communication packet A, based on a difference from the observation time of the communication packet A. Further, the acquisition unit 110 recognizes, as a “first packet” related to the transmission source “b.b.b.6”, the communication packet E that is a communication packet observed “within 30 seconds from the observation of the first packet” but has a different transmission source. In other words, in the example in FIG. 6, the acquisition unit 110 determines the communication packets A to C as a range of data for generating one piece of behavior information. Note that, although not illustrated, the acquisition unit 110 also determines a range of data for generating one piece of behavior information for the communication packet D and the communication packet E similarly to the case of the communication packets A to C.

Then, the acquisition unit 110 acquires behavior information. Specifically, the acquisition unit 110 can acquire behavior information (for example, “23, 80, 8080”) indicating a combination of destination TCP port numbers from the communication packets A to C, based on the generation rule in the first row in FIG. 5. Further, the acquisition unit 110 can acquire behavior information (for example, “23(1)→80(1)→8080(1)”) indicating the number of occurrence times and an occurrence order of the destination TCP port from the communication packets A to C, based on the generation rule in the second row in FIG. 5.

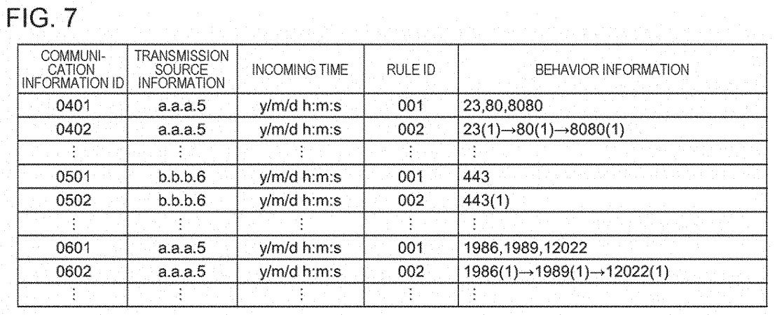

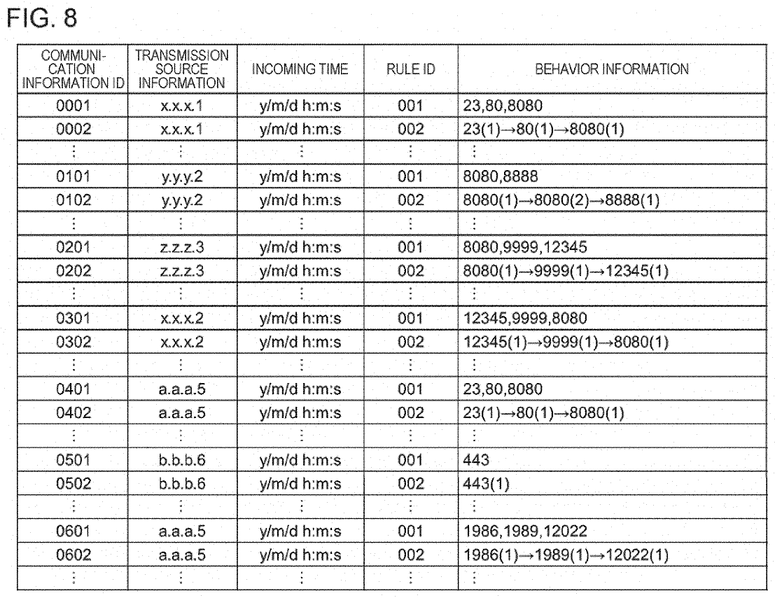

Then, the acquisition unit 110 generates communication information by associating the behavior information and the transmission source information with each other (for example: FIG. 7). FIG. 7 is a diagram illustrating one example of communication information generated based on the observation result of the communication illustrated in FIG. 6. In the example in FIG. 7, each record is formed of five columns that are a “communication information ID”, “transmission source information”, an “incoming time”, a “rule ID”, and “behavior information”. The “communication information ID” is information for identifying each piece of communication information. The “communication information ID” is automatically assigned as a value unique to communication information during generation of the communication information. The “transmission source information” is information indicating a transmission source associated with each piece of communication information. Information that can identify a transmission source of communication, such as a source IP address included in an IP header of a communication packet, for example, is set for “transmission source information”. The “incoming time” is information related to a time at which communication associated with each piece of communication information is performed. For example, an observation time of a first packet is set as an incoming time. The “rule ID” is information indicating a generation rule applied when behavior information included in communication information is generated. The behavior information generated by a generation rule indicated by the “rule ID” is stored in the “behavior information”. For example, as illustrated in FIG. 8, the acquisition unit 110 stores generated communication information in a predetermined storage region (for example, the storage device 1040). FIG. 8 is a diagram illustrating one example of communication information accumulated in the predetermined storage region. However, the communication information is not limited to the example in FIG. 8. For example, the acquisition unit 110 may include, in the communication information, detailed information (for example, WHOIS information that can be acquired based on a source IP address, and the like) that can be acquired based on transmission source information. The WHOIS information is information effective when a network administrator analyzes a communication risk.

Referring back to FIG. 4, the classification unit 120 classifies the communication information, based on the behavior information (S104). Specifically, the classification unit 120 selects one piece of communication information from the communication information acquired by the processing in S102, and compares a piece of behavior information included in the selected communication information with a piece of behavior information of other communication information. For example, it is assumed that the communication information as illustrated in FIG. 8 is accumulated, and the classification unit 120 selects communication information with a communication information ID of “0501”. In this case, the classification unit 120 can determine that there is no communication information including the same behavior information as behavior information “443” associated with the communication information (i.e., that communication behavior of the communication information is first observed). In this case, the classification unit 120 classifies the communication information with the communication information ID of “0501” as an unprecedented group. For example, the classification unit 120 newly generates flag information that uniquely indicates a classification to which behavior information included in the communication information with the communication information ID of “0501” belongs, and provides the newly generated flag information to the communication information. In this way, a classification associated with the communication behavior that has never observed in the sensor apparatus 30 is newly generated. Further, it is assumed that the classification unit 120 selects communication information with a communication information ID of “0401”. In this case, the classification unit 120 can determine one piece of communication information (communication information with a communication information ID of “0001”) including the same behavior information as that of behavior information “23, 80, 8080” associated with the communication information. In this case, the classification unit 120 classifies the communication information with the communication information ID of “0401” as the same group as the communication information with the communication ID of “0001”. For example, by providing the same flag information as flag information provided to the communication information with the ID of “0001” to the communication information with the communication information ID of “0401”, the classification unit 120 can classify the pieces of the communication information into the same group.

Then, the output unit 130 outputs a result of classification based on the behavior information together with the transmission source information (S106). For example, the output unit 130 can output, to an output apparatus 40 (a display, and the like) for a network administrator, a message such as “Communication behavior performed by transmission source a.a.a.5 is observed twice in total.” and “Communication behavior performed by transmission source b.b.b.6 is unprecedented behavior”. A network administrator can determine a risk of the communication, based on such information.

Further, as illustrated in FIG. 7, when information related to a communication time is included in communication information, the output unit 130 may further output, based on the communication time, an occurrence interval of communication belonging to each classification determined based on behavior information. For example, the output unit 130 can output a message such as “Communication behavior performed by transmission source a.a.a.5 is second time, after a lapse of XX days”. In this way, a network administrator can provide beneficial information for a risk analysis.

Further, when information related to a communication time is included in communication information, the output unit 130 may be configured in such a way as to output communication time distribution information by classification determined based on behavior information, by using the communication time of each piece of the communication information. Herein, the communication time distribution information is information indicating a distribution of time at which communication is performed by classification determined based on behavior information. Specifically, the output unit 130 may be configured in such a way as to output communication time distribution information by plotting communication by classification, based on the communication time of each piece of the communication information, in a multidimensional space including at least an axis indicating a time. A network administrator can easily recognize a trend of the communication by classification, based on such information.

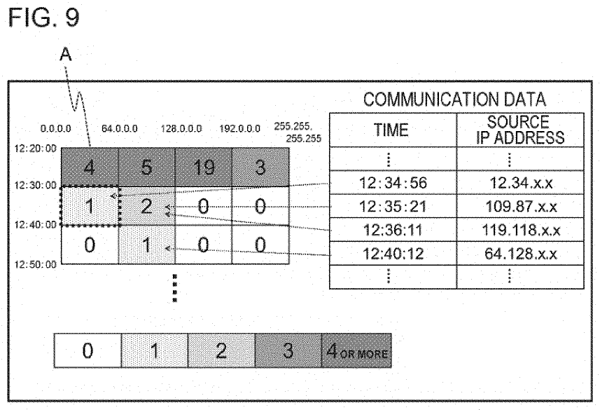

FIG. 9 illustrates a specific output example of communication time distribution information. FIG. 9 is a diagram illustrating one example of an output screen that displays the communication time distribution information. FIG. 9 illustrates a two-dimensional space A including a vertical axis as a time axis and a horizontal axis as an axis of a source IP address. Note that a vertical resolution and a horizontal resolution are “3” and “4”, respectively, in the two-dimensional space A illustrated in FIG. 9. Further, the two-dimensional space A in the screen illustrated in FIG. 9 indicates an observation result of communication by source IP address in a period from “12:20:00” to “12:50:00” on a certain day.

The communication analysis apparatus 10 according to the present example embodiment can output the screen as illustrated in FIG. 9 as follows, for example. First, the classification unit 120 collects “communication data” serving as a basis of information to be displayed on the two-dimensional space A. Herein, the classification unit 120 collects the “communication data” by classification based on behavior information. As a specific example, the classification unit 120 acquires, for communication having the same “combination of destination TCP port numbers”, data related to a time and a source IP address of the communication. As a result, data as illustrated in the “communication data” in FIG. 9 are collected. Then, the classification unit 120 selects one piece of data from the collected “communication data”. Then, the classification unit 120 determines a region (block) of the two-dimensional space A, based on a “time” or a “source IP address” of the selected data. As a specific example, a case where the classification unit 120 selects data whose time is “12:34:56” and source IP address is “12.34.x.x” is considered. In this case, the classification unit 120 can determine a region surrounded by a dotted line in the diagram as a region associated with the selected data. Then, the classification unit 120 increments a variable defined as the number of pieces of data included in the determined region (block). The classification unit 120 can eventually generate data for drawing the communication time distribution information as illustrated in FIG. 9 by performing the above-described operation on each piece of communication data. Then, the output unit 130 outputs the communication time distribution information, based on the drawing data generated by the classification unit 120. At this time, as illustrated in FIG. 9, the output unit 130 may change a color pattern of each region in response to the number of pieces of data for each region in the two-dimensional space A. In this way, a supervisor of a network security can further intuitively recognize a trend (distribution situation in terms of time) of communication by classification. Note that FIG. 9 illustrates an example in which, as the number of pieces of data for each region is greater, the region is displayed in a darker color.

However, an output content by the output unit 130 is not limited to the example in FIG. 9. For example, the output unit 130 may output communication time distribution information by using a two-dimensional space including a first axis indicating a “time” and a second axis of a “combination of destination TCP port numbers”. Herein, the “combination of destination TCP port numbers” is one example of classification based on behavior information. In this case, a screen including information that indicates in time series an occurrence situation of communication by combination of destination TCP port numbers (for example, “23, 80, 8080”, “443”, and the like) is output.

Further, a multidimensional space that does not include a time axis may be used. For example, a two-dimensional space including a first axis indicating a source port number and a second axis indicating a destination port number may be used. In this case, the output unit 130 can output information indicating an occurrence frequency of communication by combination of the source port number and the destination port number.

### Second Example Embodiment

### <Outline>

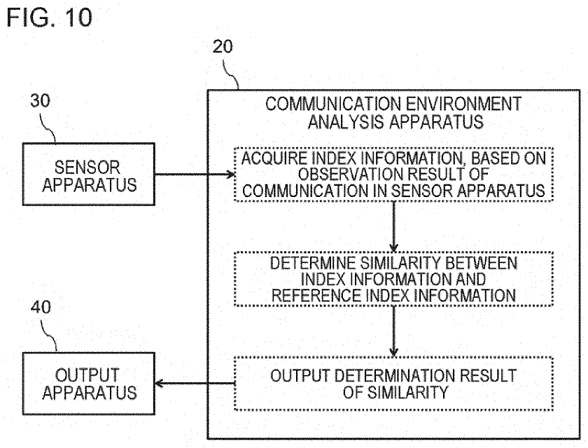

FIG. 10 is a diagram schematically illustrating processing performed by a communication environment analysis apparatus 20 according to a second example embodiment. The communication environment analysis apparatus 20 includes functions of analyzing a content of communication observed (received) in a sensor apparatus 30, and determining a risk of the sensor apparatus 30 from the analysis result. Similarly to the first example embodiment, the sensor apparatus 30 is an apparatus for observing communication from a transmission source (communication apparatus), which is not illustrated, on a network. The sensor apparatus 30 outputs a result of observing communication from the transmission source on the network to the communication environment analysis apparatus 20 or a not-illustrated external storage apparatus at predetermined timing, for example. Note that, although not illustrated in FIG. 10, the plurality of sensor apparatuses 30 may be present on the network.

The communication environment analysis apparatus 20 analyzes communication observed in the sensor apparatus 30, and acquires information (hereinafter, also expressed as “index information”) that serves as an index for measuring soundness of a network environment of the sensor apparatus 30. Note that the analysis may be performed in the sensor apparatus 30. In this case, the sensor apparatus 30 outputs information including a result of the analysis (index information) to the communication environment analysis apparatus 20 or the not-illustrated external storage apparatus.

The communication environment analysis apparatus 20 compares the acquired index information with index information (hereinafter, expressed as “reference index information”) about a network environment that serves as a determination reference of soundness. Then, the communication environment analysis apparatus 20 determines similarity between the index information of the sensor apparatus 30 and the reference index information, based on the comparison result. Then, the communication environment analysis apparatus 20 outputs a determination result of the similarity between the index information of the sensor apparatus 30 and the reference index information to a terminal for an administrator of a network security, for example. For example, it is assumed that there is a first sensor apparatus 30 that has already been known to have high soundness, and index information of the first sensor apparatus 30 is used as reference index information. In this case, the communication environment analysis apparatus 20 can conjecture that a second sensor apparatus 30 to be compared having higher similarity to the index information (reference index information) of the first sensor apparatus 30 has higher soundness. Further, it is assumed that there is a first sensor apparatus 30 that has already been known to have low soundness, and index information of the first sensor apparatus 30 is used as reference index information. In this case, the communication environment analysis apparatus 20 can conjecture that a sensor apparatus 30 to be compared having higher similarity to the index information (reference index information) of the first sensor apparatus 30 has lower soundness.

### <Action and Effect>

The communication environment analysis apparatus 20 according to the present example embodiment outputs a determination result of similarity between index information that measures soundness of a network environment of the sensor apparatus 30 and reference index information that serves as a determination reference of the soundness. The information output from the communication environment analysis apparatus 20 may be a clue for an administrator of a network security to find an unknown cyber attack. For example, when index information of the sensor apparatus 30 that is frequently targeted by a cyber attack is used as reference index information, there is a higher possibility of being a target of an unknown cyber attack as a trend closer to the reference index information is indicated. An administrator of the network security can perform, for example, such an analysis by using an output result of the communication environment analysis apparatus 20. Then, an administrator of the network security can take advance measures of increasing soundness of a network environment in such a way as to prevent damage of an unknown cyber attack from expanding.

### <Functional Configuration Example>

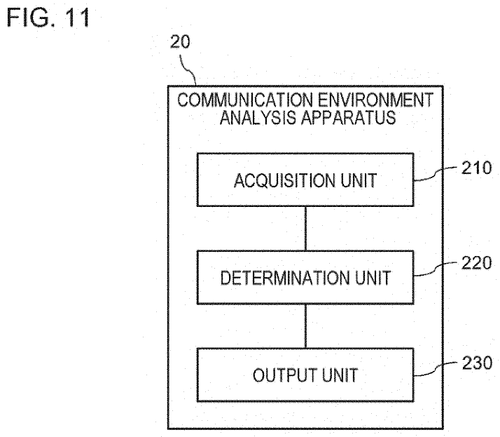

FIG. 11 is a diagram schematically illustrating a functional configuration of the communication environment analysis apparatus 20 according to the second example embodiment.

As illustrated in FIG. 11, the communication environment analysis apparatus 20 includes an acquisition unit 210, a determination unit 220, and an output unit 230.

The acquisition unit 210 acquires index information based on communication observed by the sensor apparatus 30 on a network. The index information is information that serves as an index for measuring soundness of a network environment of the sensor apparatus 30. The determination unit 220 determines similarity between the index information acquired by the acquisition unit 210 and reference index information. The reference index information is index information of a network environment that serves as a reference. The output unit 230 performs outputting, based on a determination result of similarity by the determination unit 220.

### <Hardware Configuration Example of Communication Analysis Apparatus 10>

Each functional component unit of the communication environment analysis apparatus 20 may be achieved by hardware (for example, a hard-wired electronic circuit, and the like) that achieves each functional component unit, and may be achieved by a combination (for example, a combination of an electronic circuit and a program that controls the electronic circuit, and the like) of hardware and software. Hereinafter, a case where each functional component unit of the communication environment analysis apparatus 20 is achieved by the combination of hardware and software will be further described.

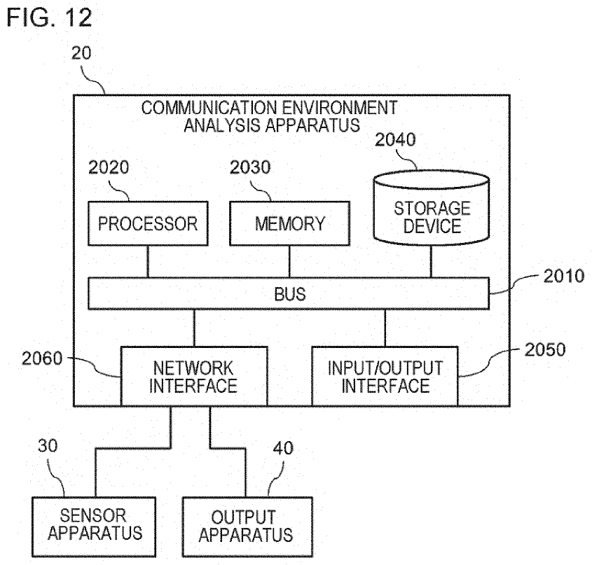

FIG. 12 is a block diagram illustrating a hardware configuration of the communication environment analysis apparatus 20. As illustrated in FIG. 12, the communication environment analysis apparatus 20 includes a bus 2010, a processor 2020, a memory 2030, a storage device 2040, an input/output interface 2050, and a network interface 2060.

The bus 2010 is a data transmission path for allowing the processor 2020, the memory 2030, the storage device 2040, the input/output interface 2050, and the network interface 2060 to transmit and receive data with one another. However, a method of connecting the processor 2020 and the like to each other is not limited to a bus connection.

The processor 2020 is a processor achieved by a central processing unit (CPU), a graphics processing unit (GPU), and the like.

The memory 2030 is a main storage configured with a random access memory (RAM) and the like.

The storage device 2040 is an auxiliary storage configured with a hard disk drive (HDD), a solid state drive (SSD), a memory card, a read only memory (ROM), or the like. The storage device 2040 stores a program module that achieves each function (such as the acquisition unit 210, the determination unit 220, and the output unit 230) of the communication environment analysis apparatus 20. The processor 2020 reads each program module onto the memory 2030 and executes the program module, and thus each function associated with the program module is achieved.

The input/output interface 2050 is an interface for connecting the communication environment analysis apparatus 20 and various types of input/output device. An input device, such as a keyboard and a mouse, and an output device, such as a speaker and a display, may be connected to the input/output interface 2050.

The network interface 2060 is an interface for connecting the communication environment analysis apparatus 20 to a network. The network is, for example, a local area network (LAN) and a wide area network (WAN). A method of the network interface 1060 connecting to the network may be a wireless connection or a wired connection. The communication environment analysis apparatus 20 can communicate with the sensor apparatus 30 on the network, another not-illustrated external apparatus, and the like via the network interface 2060.

Note that FIG. 12 is merely an exemplification, and the hardware configuration of the communication environment analysis apparatus 20 is not limited to the configuration illustrated in FIG. 12.

### <Flow of Processing>

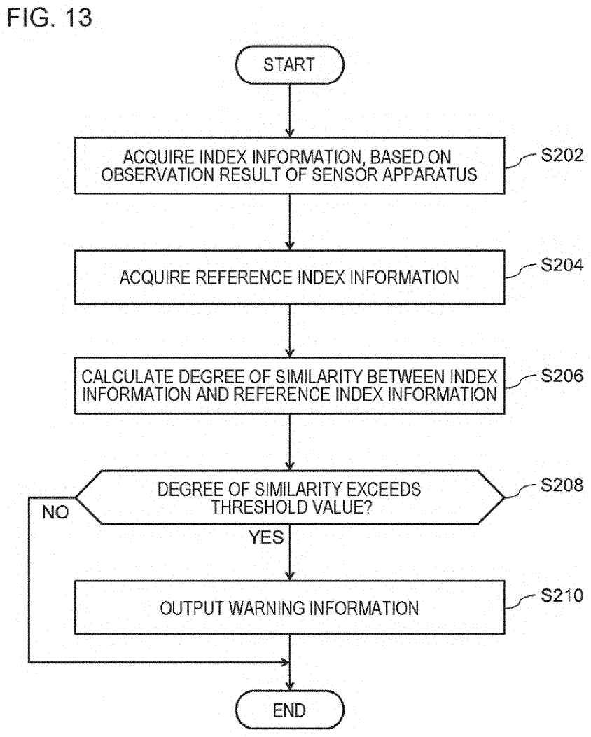

FIG. 13 is a flowchart illustrating a flow of processing performed by the communication environment analysis apparatus 20 according to the second example embodiment. Hereinafter, the processing performed by the communication environment analysis apparatus 20 will be described along the flowchart in FIG. 13.

First, the acquisition unit 210 acquires index information, based on an observation result of communication made by the sensor apparatus 30 (S202). The acquisition unit 210 operates as follows, for example.

First, the acquisition unit 210 acquires raw data of a communication packet observed (received) by the sensor apparatus 30. The communication packet includes information related to a transmission control protocol (TCP) or a user datagram protocol (UDP) and information related to an internet protocol (IP). Based on the pieces of information, the acquisition unit 210 can acquire index information. For example, the acquisition unit 210 can acquire index information, based on information, being included in a communication packet, such as a destination port number (destination TCP port number or destination UDP port number), a control flag of a TCP packet, a destination IP address, and a source IP address.

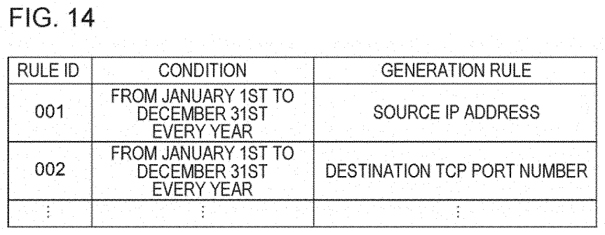

Specifically, the acquisition unit 210 acquires the index information according to a predetermined rule (for example: FIG. 14). FIG. 14 is a diagram illustrating one example of rule information that defines a generation rule of index information. The information illustrated in FIG. 14 is stored in advance in a storage region such as the memory 2030 and the storage device 2040, for example. In the example in FIG. 14, each record is formed of three columns that are a “rule identifier (ID)”, a “condition”, and a “generation rule”. The “rule ID” is information for identifying each piece of rule information. The “condition” is information for determining a range of data for generating one piece of index information, and any information may be set therein. For example, a condition that is “from January 1st to December 31st every year” is set in first and second rows in FIG. 14. In this case, one or more communication packets observed in a temporal section of “from January 1st to December 31st every year” are determined as data for generating one piece of index information. The “generation rule” is information for defining a generation rule of behavior information, and any information may be set therein. The acquisition unit 210 acquires index information from the above-described “one or more communication packets” according to a definition of the “generation rule”. For example, when the “generation rule” in the first row in the example in FIG. 14 is applied, the acquisition unit 210 extracts a source IP address from each of one or more communication packets.

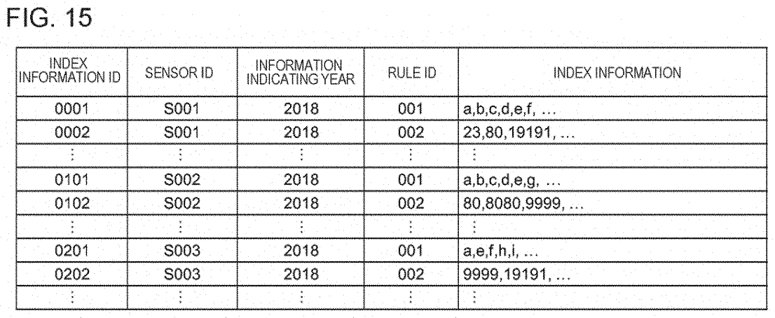

The acquisition unit 210 acquires index information for each sensor apparatus 30 being a target, and stores the index information in a predetermined storage region (for example: FIG. 15). FIG. 15 is a diagram illustrating one example of index information acquired by the acquisition unit 210. In the example in FIG. 15, each record is formed of five columns that are an “index information ID”, a “sensor ID”, an “information indicating year”, a “rule ID”, and “index information”. The “index information ID” is information for identifying each piece of index information. The “index information ID” is automatically assigned as a value unique to index information during generation of the index information. The “sensor ID” is an identifier unique to each sensor apparatus 30. The “information indicating year” is information indicating a year in which index information is generated. The information may be changed by the “condition” for determining a range of data for generating one piece of index information. The “rule ID” is information indicating a generation rule applied when behavior information included in communication information is generated. The index information generated by the generation rule indicated by the “rule ID” is stored in the “index information”.

Referring back to FIG. 13, the determination unit 220 acquires reference index information (S204). For example, when the sensor apparatus 30 as a reference is preset, the determination unit 220 can acquire index information of the sensor apparatus 30 as reference index information. Further, index information acquired as a result of experimentally operating the sensor apparatus 30 as a decoy may be prepared as reference index information in the storage device 2040 and the like.

Then, the determination unit 220 determines similarity between the index information and the reference index information. The determination unit 220 operates as follows, for example. The determination unit 220 first calculates a degree of similarity between the index information and the reference index information (S206). As one example, the determination unit 220 determines a source IP address included in both of the index information and the reference index information, based on the index information and the reference index information. In other words, the determination unit 220 determines a transmission source (source IP address) observed commonly in both of the sensor apparatus 30 to be analyzed and a sensor apparatus being a determination reference. Then, the determination unit 220 calculates, as a degree of similarity to the reference index information, a proportion of the source IP address determined above to all source IP addresses included in the reference index information. As another one example, the determination unit 220 determines a destination TCP port number included in both of the index information and the reference index information, based on the index information and the reference index information. In other words, the determination unit 220 determines a destination TCP port number observed commonly in both of the sensor apparatus 30 to be analyzed and a sensor apparatus being a determination reference. Then, the determination unit 220 calculates, as a degree of similarity to the reference index information, a proportion of the destination TCP port number determined above to all destination port numbers included in the reference index information.

Then, the determination unit 220 determines whether the degree of similarity calculated in the processing in S206 exceeds a predetermined threshold value (S208). The predetermined threshold value is predefined in a program module of the determination unit 220, for example.

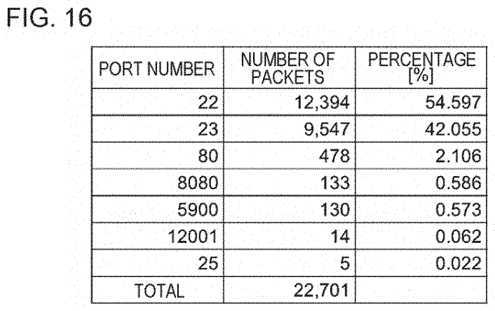

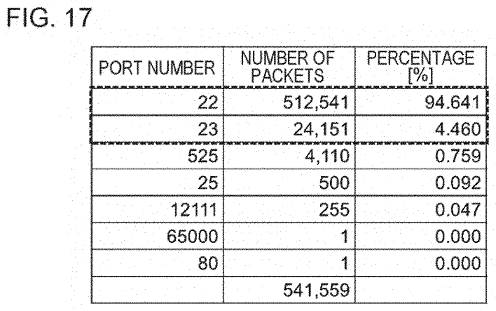

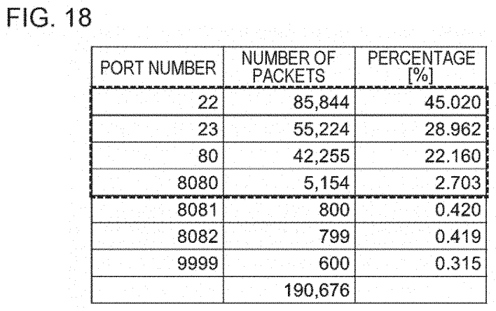

Herein, a specific flow of determining similarity between index information and reference index information by the determination unit 220 will be described by using FIGS. 16 to 18. FIG. 16 is a diagram illustrating one example of reference index information of the sensor apparatus 30 that serves as a determination reference. FIGS. 17 and 18 are diagrams each illustrating one example of index information of the sensor apparatus 30 to be analyzed. FIGS. 16 to 18 illustrate an example of using a destination TCP port number as index information.

Herein, destination TCP port numbers included in the reference index information in FIG. 16 are “22, 23, 80, 8080, 5900, 12001, 25” in descending order of occurrence frequency. Further, destination TCP port numbers included in the index information in FIG. 17 are “22, 23, 525, 25, 12111, 65000, 80” in descending order of occurrence frequency. Further, destination

TCP port numbers included in the index information in FIG. 18 are “22, 23, 80, 8080, 8081, 8082, 9999” in descending order of occurrence frequency.

In this case, the determination unit 220 can calculate, as a degree of similarity, a degree of coincidence between the reference index information and the index information for the occurrence frequency of the destination port number. For example, the determination unit 220 can calculate a degree of similarity between the reference index information in FIG. 16 and the index information in FIG. 17 and a degree of similarity between the reference index information in FIG. 16 and the index information in FIG. 18 to be “2/7” and “4/7”, respectively. In this case, the determination unit 220 can determine that the index information in FIG. 18 is closer to the reference index information than the index information in FIG. 17 is. Furthermore, it is assumed that a predetermined threshold value is “50%”. In this case, the determination unit 220 can determine that the “index information in FIG. 17 and the reference index information are not similar”. Further, the determination unit 220 can determine that the “index information in FIG. 18 and the reference index information are similar”.

Referring back to FIG. 13, the determination unit 220 notifies the output unit 230 of whether the degree of similarity exceeds the predetermined threshold value. The output unit 230 performs an output operation according to the notification received from the determination unit 220. Note that it is assumed herein that index information of the sensor apparatus 30 having low soundness is set as reference identification information. When the output unit 230 receives the notification indicating that the degree of similarity exceeds the predetermined threshold value from the determination unit 220 (S208: YES), the output unit 230 outputs warning information about soundness of the sensor apparatus 30 to be analyzed (S210). For example, the output unit 230 outputs, to a terminal for a supervisor of a network security, a message that prompts advance measures for a network environment of the sensor apparatus 30 to be analyzed, and the like. On the other hand, when the output unit 230 receives the notification indicating that the degree of similarity does not exceed the predetermined threshold value from the determination unit 220 (S208: NO), the output unit 230 does not output warning information. In this case, the output unit 230 may output a message indicating that the network environment of the sensor apparatus 30 to be analyzed does not have a problem to the terminal for a supervisor of the network security.

Further, the communication environment analysis apparatus 20 according to the present example embodiment may acquire the communication time distribution information described in the first example embodiment as index information, and perform the above-described processing. Specifically, the acquisition unit 210 acquires the communication time distribution information for each sensor apparatus 30 to be analyzed. The determination unit 220 determines similarity between the communication time distribution information and communication time distribution information used as reference index information for each sensor apparatus 30 to be analyzed. Note that the communication time distribution information used as the reference index information is, for example, communication time distribution information acquired as a result of experimentally operating the sensor apparatus 30 as a decoy described above, and the like. Such reference index information is stored in advance in the storage device 2040 and the like, for example. As a specific example, the determination unit 220 can determine similarity as follows.

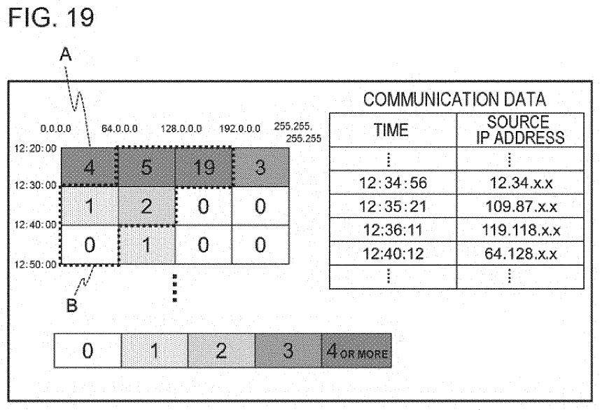

First, the determination unit 220 calculates a difference from reference index information in number of pieces of data counted for each region. Then, the determination unit 220 determines a region in which the difference is equal to or less than a predetermined threshold value, based on the difference calculated for each region. Then, the determination unit 220 can calculate, as a degree of similarity to the reference index information, a proportion of the determined region to a total number of regions. Then, the output unit 230 outputs, for example, a screen as illustrated in FIG. 19 as information indicating the degree of similarity between index information and the reference index information. FIG. 19 is a diagram illustrating one example of a screen including information indicating a degree of similarity between index information and reference index information. The output unit 230 provides a predetermined mark (for example, a frame B indicated by a dotted line in FIG. 19) to a region in which a result similar to the reference index information is acquired in a two-dimensional space A including a vertical axis as a time axis and a horizontal axis as an axis of a source IP address, for example. According to the information as illustrated in FIG. 19, a common portion between the index information of the sensor apparatus 30 and the reference index information can be easily recognized.

While the example embodiments of the present invention have been described with reference to the drawings, the example embodiments are only exemplification of the present invention, and various configurations other than the above-described example embodiments can also be employed.

Further, the plurality of steps (processing) are described in order in the plurality of flowcharts used in the above-described description, but an execution order of steps performed in each of the example embodiments is not limited to the described order. In each of the example embodiments, an order of illustrated steps may be changed within an extent that there is not harm in context. Further, each of the example embodiments described above can be combined within an extent that a content is not inconsistent.

A part or the whole of the above-mentioned example embodiment may also be described in supplementary notes below, which is not limited thereto.

1.

A communication analysis apparatus, including:

an acquisition unit for acquiring, for communication observed by a sensor apparatus on a network, communication information including behavior information indicating behavior of the communication and transmission source information indicating a transmission source of the communication;

a classification unit for classifying the acquired communication information, based on the behavior information; and

an output unit for outputting a classification result of the communication information based on the behavior information, together with the transmission source information.

2.

The communication analysis apparatus according to supplementary note 1, in which the behavior information includes information related to at least one of a destination port number, a control flag of a transmission control protocol (TCP) packet, and a destination internet protocol (IP) address.

3.

The communication analysis apparatus according to supplementary note 1 or 2, in which information about a communication time is included in the communication information, in which

the output unit outputs, by using the information about the communication time, communication time distribution information indicating a distribution of time at which communication is performed by classification based on the behavior information.

4.

The communication analysis apparatus according to supplementary note 3, in which

the output unit outputs the communication time distribution information by using a multidimensional space including at least an axis indicating a time.

5.

The communication analysis apparatus according to supplementary note 3, wherein the output unit outputs, by using the information about the communication time, information indicating an occurrence interval of communication in each classification determined based on the behavior information.

6.

A communication analysis method performed by a computer, the method including:

acquiring, for communication observed by a sensor apparatus on a network, communication information including behavior information indicating behavior of the communication and transmission source information indicating a transmission source of the communication;

classifying the acquired communication information, based on the behavior information; and

outputting a classification result of the communication information based on the behavior information, together with the transmission source information.

7.

The communication analysis method according to supplementary note 6, in which

the behavior information includes information related to at least one of a destination port number, a control flag of a transmission control protocol (TCP) packet, and a destination internet protocol (IP) address.

8.

The communication analysis method according to supplementary note 6 or 7, in which information about a communication time is included in the communication information, the method including,

by the computer, outputting, by using the information about the communication time, communication time distribution information indicating a distribution of time at which communication is performed by classification based on the behavior information.

9.

The communication analysis method according to supplementary note 8, further including,

by the computer, outputting the communication time distribution information by using a multidimensional space including at least an axis indicating a time.

10.

The communication analysis method according to supplementary note 8, further including,

by the computer, outputting, by using the information about the communication time, information indicating an occurrence interval of communication in each classification determined based on the behavior information.

11.

A program causing a computer to execute the communication analysis method according to any one of supplementary notes 6 to 10.

12.

A communication environment analysis apparatus, including:

an acquisition unit for acquiring index information that serves as an index for measuring, based on communication observed by a sensor apparatus on a network, soundness of a network environment of the sensor apparatus;

a determination unit for determining similarity between the acquired index information and reference index information being index information of a network environment that serves as a reference; and

an output unit for performing outputting based on a determination result of the similarity.

13.

The communication environment analysis apparatus according to supplementary note 12, wherein

the index information includes at least one of information about a destination port number and information about a source internet protocol (IP) address.

14.

The communication environment analysis apparatus according to supplementary note 13, in which

the determination unit
determines a number of pieces of information common to both of the index information and the reference index information for at least either one of a destination port number or a source IP address, and
calculates, as information indicating the similarity, a proportion of the determined number to a total number of pieces of information included in the reference index information.
   15.

A communication environment analysis method performed by a computer, the method including:

acquiring index information that serves as an index for measuring, based on communication observed by a sensor apparatus on a network, soundness of a network environment of the sensor apparatus;

determining similarity between the acquired index information and reference index information being index information of a network environment that serves as a reference; and performing outputting based on a determination result of the similarity.

16.

The communication environment analysis method according to supplementary note 15,in which

the computer includes at least one of information about a destination port number and information about a source Internet Protocol (IP) address.

17.

The communication environment analysis method according to supplementary note 16, further including:

by the computer,

determining a number of pieces of information common to both of the index information and the reference index information for at least either one of a destination port number or a source IP address; and

calculating, as information indicating the similarity, a proportion of the determined number to a total number of pieces of information included in the reference index information.

18.

A program causing a computer to execute the communication environment analysis method according to any one of supplementary notes 15 to 17.

This application is based upon and claims the benefit of priority from Japanese patent application No. 2018-118955, filed on Jun. 22, 2018, the disclosure of which is incorporated herein in its entirety by reference.

What is claimed is:

1. A communication analysis apparatus, comprising:
an acquisition unit for acquiring, for communication observed by a sensor apparatus on a network, communication information including behavior information indicating behavior of the communication and transmission source information indicating a transmission source of the communication;
a classification unit for classifying the acquired communication information, based on the behavior information; and
an output unit for outputting a classification result of the communication information based on the behavior information, together with the transmission source information.

2. The communication analysis apparatus according to claim 1, wherein
the behavior information includes information related to at least one of a destination port number, a control flag of a transmission control protocol (TCP) packet, and a destination internet protocol (IP) address.

3. The communication analysis apparatus according to claim 1, wherein
information about a communication time is included in the communication information, wherein
the output unit outputs, by using the information about the communication time, communication time distribution information indicating a distribution of time at which communication is performed by classification based on the behavior information.

4. The communication analysis apparatus according to claim 3, wherein
the output unit outputs the communication time distribution information by using a multidimensional space including at least an axis indicating a time.

5. The communication analysis apparatus according to claim 3, wherein
the output unit outputs, by using the information about the communication time, information indicating an occurrence interval of communication in each classification determined based on the behavior information.

6. A communication analysis method performed by a computer, the method comprising:
acquiring, for communication observed by a sensor apparatus on a network, communication information including behavior information indicating behavior of the communication and transmission source information indicating a transmission source of the communication;
classifying the acquired communication information, based on the behavior information; and
outputting a classification result of the communication information based on the behavior information, together with the transmission source information.

7. The communication analysis method according to claim 6, wherein
the behavior information includes information related to at least one of a destination port number, a control flag of a transmission control protocol (TCP) packet, and a destination internet protocol (IP) address.

8. The communication analysis method according to claim 6, wherein
information about a communication time is included in the communication information, the method comprising,
by the computer, outputting, by using the information about the communication time, communication time distribution information indicating a distribution of time at which communication is performed by classification based on the behavior information.

9. The communication analysis method according to claim 8, further comprising,
by the computer, outputting the communication time distribution information by using a multidimensional space including at least an axis indicating a time.

10. The communication analysis method according to claim 8, further comprising,
by the computer, outputting, by using the information about the communication time, information indicating an occurrence interval of communication in each classification determined based on the behavior information.

11. (canceled)

12. A communication environment analysis apparatus, comprising:
an acquisition unit for acquiring index information that serves as an index for measuring, based on communication observed by a sensor apparatus on a network, soundness of a network environment of the sensor apparatus;
a determination unit for determining similarity between the acquired index information and reference index information being index information of a network environment that serves as a reference; and
an output unit for performing outputting based on a determination result of the similarity.

13. The communication environment analysis apparatus according to claim 12, wherein
the index information includes at least one of information about a destination port number and information about a source internet protocol (IP) address.

14. The communication environment analysis apparatus according to claim 13, wherein
the determination unit
determines a number of pieces of information common to both of the index information and the reference index information for at least either one of a destination port number or a source IP address, and
calculates, as information indicating the similarity, a proportion of the determined number to a total number of pieces of information included in the reference index information.

15. A communication environment analysis method performed by a computer, the method comprising:
acquiring index information that serves as an index for measuring, based on communication observed by a sensor apparatus on a network, soundness of a network environment of the sensor apparatus;
determining similarity between the acquired index information and reference index information being index information of a network environment that serves as a reference; and
performing outputting based on a determination result of the similarity.

16. The communication environment analysis method according to claim 15, wherein
the computer includes at least one of information about a destination port number and information about a source Internet Protocol (IP) address.

17. The communication environment analysis method according to claim 16, further comprising:
by the computer,
determining a number of pieces of information common to both of the index information and the reference index information for at least either one of a destination port number or a source IP address, and
calculating, as information indicating the similarity, a proportion of the determined number to a total number of pieces of information included in the reference index information.

18. (canceled)
